(19) United States
(12) Patent Application Publication
(10) Pub. No.: US 2004/0045643 A1
(43) Pub. Date: Mar. 11, 2004

(54) Composite aluminium sheet

(76) Inventors: Ian P. Hewett, Atlanta, GA (US); Alan Gray, Banbury Oxon (GB); Keith G. Davis, Banbury Oxon (GB)

Correspondence Address: Cooper & Dunham, 1185 Avenue of the Americas, New York, NY, 10036, US

(21) Appl. No.: 10/416,777

(22) PCT Filed: Nov. 14, 2001
(86) PCT No.: PCT/GB01/05005

(30) Foreign Application Priority Data
Nov. 14, 2000 (GB) 0027706.1

(51) Int. Cl. B32B 15/10; C22F 1/04

(52) U.S. Cl. 148/535; 428/654

(57) ABSTRACT

This invention relates to a method of making a composite aluminium brazing sheet, which method comprises: providing a core sheet of a first Al alloy and a cladding sheet of a second Al alloy, wherein a) the composition of the first Al alloy is different from the composition of the second Al alloy, b) the thickness of the core sheet is greater than the thickness of the cladding sheet, and c) the hardness of the core sheet is different than the hardness of the cladding sheet, cleaning facing surfaces of the core sheet and of the cladding sheet; and cold rolling the core sheet with the cladding sheet so as to roll bond them to make a composite aluminium sheet. Also disclosed is a brazing sheet comprising a core layer of a first Al alloy containing Mg and a cladding layer of a second Al alloy.

This invention relates to a composite aluminium sheet and to a method of making it. Composite aluminium sheet is used for example as brazing sheet.

U.S. Pat. No. 2,691,815 (issued 1954) describes a method of joining together two metal sheets, of the same or different metals and the same or different thicknesses. First, facing surfaces of the two sheets are cleaned to eliminate damaging surface films, e.g. by abrasion followed by heating. Second, the two sheets are cold rolled to provide nucleal bonds at discrete points. Preferably the softer metal is work hardened, so that the two sheets are as far as possible of the same hardness. Third, the combined sheets are heated (sintered) to form a strong bond between them. Although numerous examples are given, none show the bonding together of two Al alloys.

The aluminium industry provides clad sheet consisting of a core layer and a cladding layer on a substantial scale, by the following technology. An ingot of the core alloy is cast, if necessary homogenised, scalped and cooled to ambient temperature. A slab of the cladding alloy is placed over the ingot and held in position. The composite is subjected to hot rolling (above 420° C.) in a reversing mill where the thickness is reduced down to a level of about 10 mm to 25 mm.

The plate is hot rolled in a tandem mill down to sheet 3.0-3.5 mm thick. Then the hot rolled composite sheet is cold rolled down to a desired thickness, that depends on the final product. It may be subjected to an intermediate anneal, and will generally be subjected to a final anneal in order to improve formability.

The presence of a cladding slab on top of the core ingot at least doubles the time required to be spent in the reversing mill. During passage through the reversing mill and the hot tandem mill, the cladding spreads longitudinally and laterally. A lot of mixed scrap of rather low value is generated. The yield of composite sheet is some 60-65% of the starting ingot. The thickness of the cladding may be limited because thick plates do not easily roll bond even during hot rolling. Despite its manifest disadvantages, this technology is currently used, and has been used since the 1960s, to make aluminium brazing sheet.

According to the present invention, the disadvantages of the prior technology are addressed by applying the cladding layer only after hot rolling of the core layer has been completed. Although it might be thought obviously desirable to add the cladding layer as late as possible in the thermomechanical process used to make the composite sheet, it was not at all clear that this would be possible. First, it was not clear that cold rolling would be effective to join two dissimilar sheets together by a bond strong enough to withstand stamping, deep drawing, ironing and other forming processes to which e.g. brazing sheet is subjected. Even in the conventional hot-rolling technology, roll-bonding does not occur on the first pass through a reversing mill. Second, roll-bonding has to be performed under carefully controlled conditions, such that lubricant or coolant does not enter the gap between the facing surfaces of the two sheets, and such that sticking to the rolls does not occur. The present invention addresses these concerns.

The present invention provides a method of making a composite aluminium brazing sheet, which method comprises: providing a core sheet of a first Al alloy and a cladding sheet of a second Al alloy, wherein a) the composition of the first Al alloy is different from the composition of the second Al alloy, b) the thickness of the core sheet is greater than the thickness of the cladding sheet, and c) the hardness of the core sheet is different than the hardness of the cladding sheet; cleaning facing surfaces of the core sheet and of the cladding sheet; and cold rolling the core sheet with the cladding sheet so as to roll bond them to make a composite aluminium sheet.

An Al alloy is any alloy in which aluminium is the major component. It is possible to use pure aluminium metal for the cladding sheet. The composition of the core alloy and the cladding alloy will depend on the intended use of the composite sheet. For brazing sheet, the cladding alloy is generally a 4000 series alloy (of the Aluminum Association Register) and the core alloy may be a 3000 series alloy.

The core sheet is generally required to provide desired mechanical properties such as strength and formability in the composite sheet. The cladding sheet is generally required to provide particular surface properties in the composite sheet. A cladding layer may be provided on one or both surfaces of the core layer. The thickness of a cladding layer is preferably from 2 to 30%, more preferably 5 to 15% of the thickness of a core layer, although this range is not critical. Where a core layer is clad on both sides, the thicknesses of the two cladding layers and the alloys may be the same or different.

Facing surfaces of the core sheet and the cladding sheet are cleaned to ensure that they are capable of roll bonding under cold rolling conditions. Chemical cleaning, which involves removing a surface of the underlying metal, is satisfactory, but is in general not required. It is generally sufficient to subject the surfaces to an aqueous degrease with a non-etch degreaser. It is generally not necessary to remove a thin layer of aluminium oxide or magnesium oxide surface layer. Preferably the surfaces are cleaned by metal abrasion e.g. by the use of wire brushes; this may have the effect of redistributing, rather than removing, any naturally occurring surface oxide. After this cleaning step, the facing surfaces are dried and are then ready for the cold rolling step.

The cold rolling step is preferably performed continuously on continuous strip or coil. It is envisaged that rolls may be up to 1200 mm wide and up to 1000 mm diameter, and may operate at rolling speeds up to several hundred metres per minute The core sheet and the cladding sheet to be roll-bonded may be combined either on-line or off-line. Where cladding layers are to be applied to both surfaces of a core layer, the two roll bonding operations may be effected in separate passes through a rolling mill. Since the presence of liquid e.g. coolant or lubricant, between the facing surfaces of the core sheet and the cladding sheet would inhibit roll-bonding, it is preferred that the cold rolling step for roll-bonding be effected without use of any liquid lubricant or coolant. A release agent may however be required to prevent the composite sheet from sticking to the rolls. Since sticking may nevertheless be a problem at high temperatures, it is preferred that the composite sheet exits the rolls at a temperature no greater than 50° C. The inventors have effected roll-bonding by cold rolling at a thickness reduction of as little as 15%. However this is expected to be substantially a minimum figure, and the cold-rolling step for roll bonding is preferably effected at a thickness reduction of 20-70% e.g. about 30%. Preferably the cold rolling step is effected in a single pass for each cladding sheet to be roll bonded to the core sheet.

It is a feature of the invention that the hardness of the core sheet is different than the hardness of the cladding sheet. Preferably the cladding sheet is softer than the core sheet. This is intuitively surprising. One might expect that, if one sheet is much softer than the other, that one sheet will spread longitudinally and laterally during a continuous cold rolling operation, while the other sheet is scarcely deformed, and that laterally extending waves may be set up in the cladding layer of the composite sheet which may prevent effective bonding of the two layers. The inventors have determined that, although these effects may occur to a small extent, they are not a problem in practice. And there are sound metallurgical reasons, discussed below, for using a cladding sheet that is softer than the core sheet.

The cold rolling step described above results in a composite sheet in which a cladding layer is joined to a core layer by means of a strong and continuous or substantially continuous bond. If the composite sheet is too thick for its intended use, it may be subjected to further cold rolling. This would generally be in the presence of lubricant. The composite sheet may be subjected to an intermediate anneal, e.g. because the metal is too hard for further economic rolling, and/or a final anneal e.g. to provide the metal in a softer condition having improved formability or in the production of an intermediate temper. A final anneal may be performed either below a recrystallisation temperature, particularly where the sheet is to be formed into tube, or above the recrystallisation temperature of the core layer in order to improve formability. These subsequent cold rolling and annealing steps may enhance the bond between the cladding layer and the core layer. But such steps are believed not necessary to provide a bond capable of withstanding forming operations applied to brazing sheet. It is a surprising feature of the invention that a single cold rolling pass is generally effective to provide a substantial and continuous bond between a cladding layer and a core layer, such that the composite sheet will withstand the routine handling and forming operations that it is required to undergo.

The optimum hardnesses of the cladding sheet and the core sheet are related. If the cladding sheet is fully soft, then the core sheet may be half-hard. If the cladding sheet is half-hard, then the core sheet may be fully hard, e.g. by having been substantially work-hardened by cold rolling. During the roll-bonding step, a soft cladding sheet transfers strain to the core sheet and so avoids excessive heat build-up. If the cladding sheet becomes work-hardened more rapidly than does the core sheet, then an excessive spread of the cladding sheet (leading to an effect known as “alligatoring”) may be avoided. In order that the composite sheet may be subjected to a final recrystallisation anneal to provide maximum formability, it may be necessary that the core sheet be in a partly work-hardened state before it is roll bonded with the cladding sheet. It may be convenient if the cladding sheet is slightly narrower than the core sheet. The hardnesses of the cladding sheet and of the core sheet need to be chosen in relation to their work hardening properties in order to obtain substantially equal elongation of the two.

This invention is expected to be of particular importance in relation to brazing alloy sheet of the kind comprising an aluminium-based core and on at least one side a cladding of an aluminium-based brazing alloy containing silicon as the main alloying ingredient. Brazing sheet of this kind, having good corrosion resistance and also sag resistance and post-brazed strength, is described in U.S. Pat. Nos. 5,037,707 and 5,041,343 and in WO 94/22633 (Alcan International Limited). The core alloy is a 3000 series alloy of the following composition:—

| | Core Alloy |
|---|---|
| Fe | <0.4 |
| Si | <0.2 |
| Mn | 0.7-1.7 |
| Mg | 0-0.8 |
| Cu | 0.1-1.0 |
| V and/or Cr | <0.3 |
| Zn | <0.2 |
| Ti | <0.1 |
| Others | <0.05 each, <0.15 total |
| Al | Balance. |

Mg is present in the core to provide increased strength. Mg is not normally present in the cladding. When brazing sheet is made by the conventional technique of hot rolling a core sheet containing at least 0.05% Mg, and a cladding sheet, then there is significant migration of Mg from a region of the core layer close to the interface to a region of the cladding layer close to the interface. On the other hand, when such brazing sheet is formed by roll-bonding a core sheet and a cladding sheet by cold rolling, as in the present invention, there is no substantial migration of Mg across the boundary; and this is true even if the resulting brazing sheet has been subjected to a final recrystallisation anneal. It is thus possible to tell by inspection of a sample of brazing sheet whether the cladding was applied by hot rolling or by cold rolling.

Although the present cold cladding technique creates a definite interface zone containing elements have diffused in from both the cladding layer and the core, thus demonstrating that a metallurgical bond has formed, the Mg from the core does not diffuse into the cladding material beyond this zone, and in particular the Mg concentration adjacent to the outer surface of the cladding is not increased beyond the level originally present in the cladding material. Typically the core material will have more (i.e. a higher concentration) Mn, Cu and Mg than the cladding material, and the cladding material more Si than the core so that the interface zone contains more Si than the original core material and more Mn, Cu and Mg than the original cladding material.

Thus in a further aspect the invention provides a brazing sheet comprising a core layer of a first Al alloy containing Mg and a cladding layer of a second Al alloy, in which Mg is either absent or is present at a concentration substantially lower than the first Al alloy, characterised in that there is substantially no migration of Mg from the core layer into the cladding layer. Preferably the first (core) alloy has the composition set out above.

Where the brazing sheet is subject to flux based brazing, the cladding material is typically manufactured with very low Mg levels since the Mg interferes with the brazing process. Typically Mg will be less than −0.1% in the cladding material and preferably is present only as an impurity (less than 0.05%). However, as noted above, Mg will migrate from the core material during a hot-cladding process and can raise the Mg levels in the cladding material to a level where it interferes with the flux brazing process.

The core alloy used in the present cold cladding process preferably has at least 0.05% Mg and more preferably has at least 0.1% Mg present as the clad sheet manufactured by the present process is surprisingly more tolerant of Mg in the core material than similar materials produced by hot cladding. This appears to be because the migration of Mg in the case of hot rolling the cladding sheet and core material increases the Mg concentration at the surface of the cladding where it enhances the formation of oxides during brazing and in the presence of fluoride fluxes often used in brazing, forms undesirable compounds with the flux that inhibit the brazing process. The presence of Mg at the interface between the core and cladding is however beneficial in promoting the formation of a Cu rich phase at the interface (the “brown band”), which has been found to yield enhanced corrosion resistance. The present invention has been found surprisingly to provide for sufficient diffusion of alloying elements along the interface to ensure that an effective “brown band” can form yet the Mg diffusion into the cladding layer is substantially eliminated.

Experiments have shown that the presence of a Mg concentration of 0.26% in the core material of a typical X900 alloy increases the corrosion resistance in a SWAAT test over that using a Mg concentration at 0.01%, and therefore the ability to increase the Mg in the core alloy in the present invention permits an increase in corrosion resistance without the negative effects of diffusion of Mg into the cladding layer. In typical results, the pit depth in material containing 0.26% Mg in the core after a SWAAT test of 1000 hours was only 152 microns whereas the pit depth in material containing only 0.01% Mg in the core was, under the same conditions, greater than 370 microns (complete perforation).

The present invention may be used for applying a second cladding layer to a previously formed composite. For example, a composite formed by hot-cladding of a layer on a core material, may be used as the “core” of the present process and a further cladding layer applied to either side of the “core”. This may be used, for example, to apply a second layer of a high Si aluminium alloy to an opposite side of a core material from the first such applied layer, or to create an interlayer structure using three different alloys where the core and “interlayer” come from the initial cladding operation and the outermost layer is applied by the cold-rolling operation to the “interlayer” side of the composite.

The method of the present invention involving roll bonding by cold rolling, has the following advantages over the conventional hot rolling technique:

Increase in available hot mill time;

Increased recovery;

Reduced level of mixed scrap;

Reduced usage of preheat furnaces—because it will be possible to hot roll the core alloy directly after homogenisation;

Substantially reduced process costs.

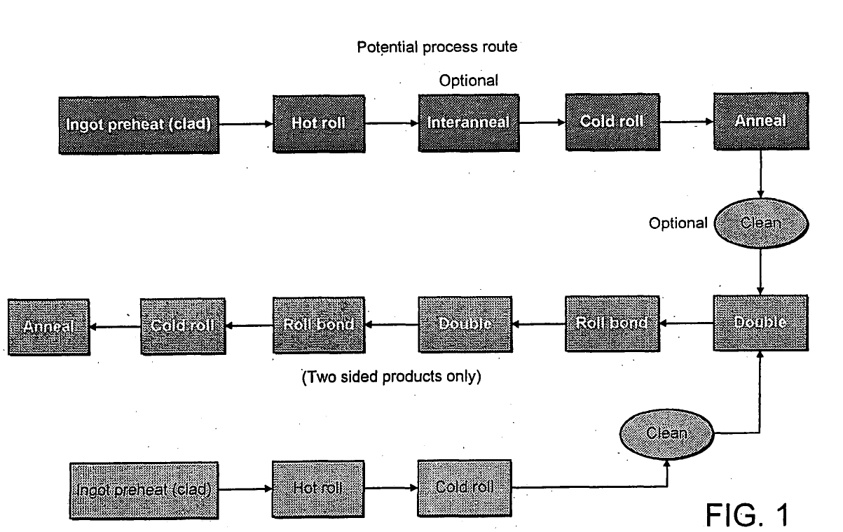

Reference is directed to the accompanying FIG. 1, a flow chart showing the sequence of steps required to convert ingots of the cladding alloy and of the core alloy to an annealed composite sheet. The sequence of steps shown is a preferred one; some of the steps might be altered or omitted, as indicated above and in the appended claims.

### EXAMPLE 1

Laboratory experiments have been performed on a batch basis on the following materials.

The core sheet was of X900 alloy (1.5% Mn, 0.6% Cu, 0.27% Mg, 0.18% Fe, 0.09% Si) in the form of a temper-rolled i.e. fully hard sheet 3.5 mm thick. The cladding alloy was an Al—Si alloy designated AA4045. Various cladding ratios i.e. 100% and 50% and 15% were investigated with the cladding soft annealed, fully hard or of intermediate hardness. The surfaces of the sheets were cleaned in various ways:—

As rolled i.e. not specially cleaned);

By manual abrasion using Scotchbrite;

By an aqueous degrease;

By a caustic etch (which removes oxide and also surface metal).

One core sheet and one cladding sheet were subjected to cold rolling at a strain level of 20-70% by a single pass through a laboratory rolling mill without lubrication. The results were as follows. Where the sheets were used in an as-rolled state, no bonding was seen. But when the surfaces of the sheets had been cleaned by any of the techniques indicated; substantial and continuous bonds were obtained when the cladding was in the fully soft condition. Higher reductions were required when the cladding was harder as set out in the following table.

Bonding as a function of cold reduction and the hardness of the cladding

| | Increasing Hardness of Cladding | | |
|---|---|---|---|
| | | Intermediate | |
| % Cold Reduction | Soft | Hardness | Fully Hard |
| 10 | X | X | X |
| 30 | Y | X | X |
| 50 | Y | Y | X |
| 70 | Y | Y | Y |

X = No Bond
Y = Bond

### EXAMPLE 2

Samples were prepared as in Example 1 and roll bonded after cleaning by abrasion with Scotchbrite. The cladding, having the same thickness as the core, was in the fully soft condition and the core fully hard. 85% cold reduction was achieved in two passes, the first being 50% reduction. Both passes were without lubrication. Bond strength was then measured by a conventional Peel test at a strain rate of 20 mm min⁻¹ in the as rolled condition and after annealing. The results were:

| | |
|---|---|
| As rolled Peel strength: | 10 ± 2 MPa |
| After Annealing Peel Strength: | 132-605 MPa (two results) |

### EXAMPLE 3

Example 2 was repeated using AA4104 as the cladding material. This cladding is used for vacuum brazing. The peel test results were as follows:

| | |
|---|---|
| As rolled Peel strength: | 10 ± 3 MPa |
| After Annealing Peel Strength: | 147-185 MPa |

### EXAMPLE 4

Annealed material from Examples 2 and 3 were subjected to a simulated brazing cycle and a cross section through the cladding and core examined metallographically. It was noted that a brown band was formed as described in EP 691 898. This is further proof that a metallurgical bond has formed since the formation of this band requires diffusion across the interface between the core and the cladding.

### EXAMPLE 5

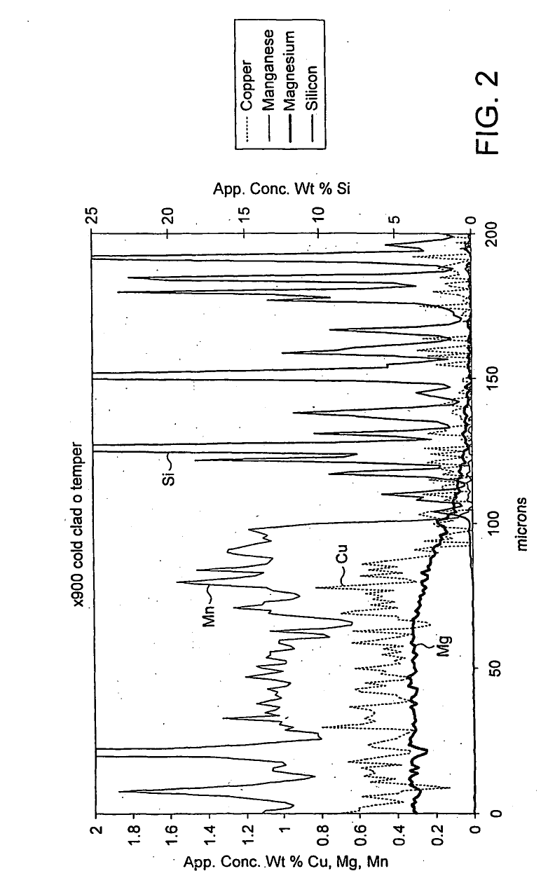

FIG. 2 is a microprobe line scan through a composite sheet according to the invention, showing the distribution of four alloying elements on either side of a boundary between a core layer and a cladding layer. Note that there is little or no sign that Mg has migrated from the core layer to the cladding layer, i.e. there is substantially no Mg present in a region of the cladding layer adjoining the boundary.

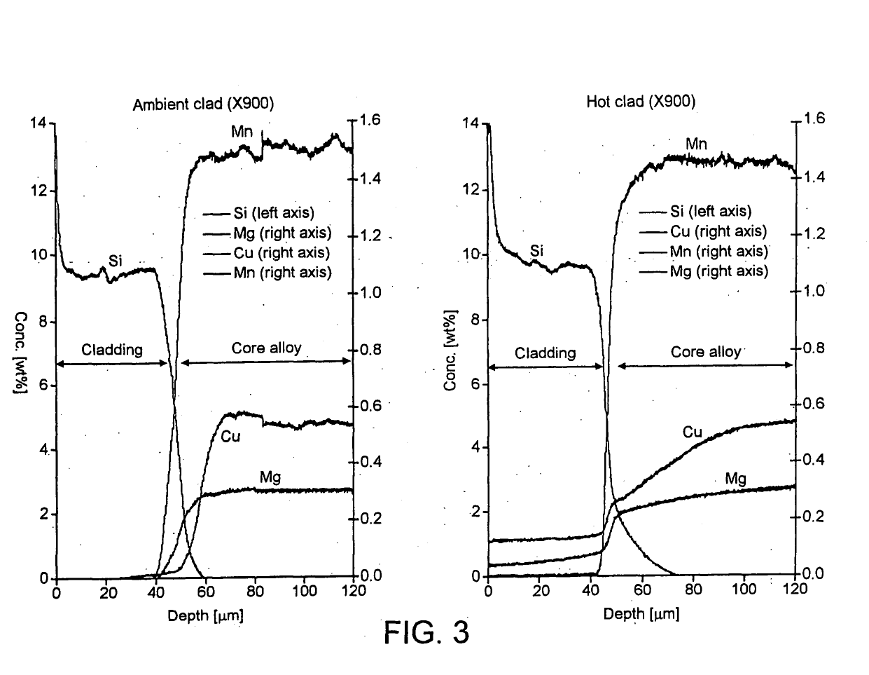

FIG. 3 is a GDEOS (Glow Discharge Optical Emission Spectroscopy) scan of the same material that produces a clearer concentration profile of the material. The scan of the material produced by the process of the present invention shows that there is a clear layer of interdiffusion formed showing that the metallurgical bonding has occurred (in accordance with the finding of a “brown band” in Example 4). The same compositions formed into a clad sheet by hot rolling show the substantial amount of Mg diffusion extending to the surface of the cladding layer which would result in greater difficulty during flux brazing.

1. A method of making a composite aluminium brazing sheet, which method comprises: providing a core sheet of a first Al alloy and a cladding sheet of a second Al alloy, wherein a) the composition of the first Al alloy is different from the composition of the second Al alloy, b) the thickness of the core sheet is greater than the thickness of the cladding sheet, and c) the hardness of the core sheet is different than the hardness of the cladding sheet; cleaning facing surfaces of the core sheet and of the cladding sheet; and cold rolling the core sheet with the cladding sheet so as to roll bond them to make a composite aluminium sheet.

2. The method of claim 1, wherein the facing surfaces of the core sheet and the cladding sheet are cleaned by mechanical abrasion or by an aqueous degrease.

3. The method of claim 1 or claim 2, wherein, in the composite aluminium sheet, the thickness of a cladding layer is from 5-15% of the thickness of a core layer.

4. The method of any one of claims 1 to 3, wherein the core sheet is harder than the cladding sheet.

5. The method of any one of claims 1 to 4, wherein cold rolling is performed continuously on continuous strip or coil.

6. The method of any one of claims 1 to 5, wherein cold rolling for roll bonding is effected in a single pass with a thickness reduction of 20-70%.

7. The method of any one of claims 1 to 6, wherein cold rolling or roll bonding is effected without use of any liquid lubricant or coolant.

8. The method of any one of claims 1 to 7, wherein the composite aluminium sheet has a temperature of no more than 50° C. as it leaves the cold rolling step.

9. The method of any one of claims 1 to 8, wherein the composite aluminium sheet is subjected to cold rolling and/or to final anneal.

10. The method of any one of claims 1 to 9, wherein Mg is either absent from the second Al alloy or is present at a concentration substantially lower than in the first Al alloy, and wherein there is substantially no migration of Mg from the core sheet into the cladding sheet during the rolling process.

11. The method of any one of claims 1 to 10, wherein Mg is present in an amount of more than 0.05 wt % in the first alloy and in an amount of less than 0.05 wt % in the second alloy.

12. The method of any one of claims 1 to 11, wherein the second alloy comprises more Si than the first alloy.

13. The method of any one of claims 1 to 12, wherein the first alloy comprises more Mg, Mn and Cu than the second alloy.

14. The method of any one of claims 1 to 13, wherein an interface zone is present which comprises an Si concentration which is higher than in the first alloy and an Mn, Cu and Mg concentration which is higher than in the second alloy.

15. The method of any one of claims 1 to 14, wherein the composition of the first alloy is in wt %:

| | |
|---|---|
| Fe | <0.4 |
| Si | <0.2 |
| Mn | 0.7-1.7 |
| Mg | 0-0.8 |
| Cu | 0.1-1.0 |
| V and/or Cr | <0.3 |
| Zn | <0.2 |
| Ti | <0.1 |
| Others | <0.05 each, <0.15 total |
| Al | Balance. |

16. The method of any one of claims 1 to 15, further comprising the step of applying a further different Al alloy layer.

17. The method of claim 16, wherein the different Al alloy layer is applied to the face of the core sheet which has not been clad by the method of any one of claims 1 to 15.

18. The method of claim 16, wherein the different Al alloy layer is applied to the cladding sheet of the second Al alloy.

19. The method of any one of claims 16 to 18, wherein the core sheet comprises layers of two separated Al alloys which are both different from the cladding alloy.

20. Brazing sheet comprising a core layer of a first Al alloy containing Mg and a cladding layer of a second Al alloy, in which Mg is either absent or is present at a concentration substantially lower than the first Al alloy, characterised in that there is substantially no migration of Mg from the core layer into the cladding layer.

21. The brazing sheet of claim 20, wherein Mg is present in an amount of more than 0.05 wt % in the first alloy and in an amount of less than 0.05 wt % in the second alloy.

22. The brazing sheet of claim 20 or 21, wherein the second alloy comprises more Si than the first alloy.

23. The brazing sheet of any one of claims 20 to 22, wherein the first alloy comprises more Mg, Mn and Cu than the second alloy.

24. The brazing sheet of any one of claims 20 to 23, wherein an interface zone is present which comprises an Si concentration which is higher than in the first alloy and an Mn, Cu and Mg concentration which is higher than in the second alloy.

25. The brazing sheet of any one of claims 20 to 24, wherein the composition of the first alloy is in wt %:

| | |
|---|---|
| Fe | <0.4 |
| Si | <0.2 |
| Mn | 0.7-1.7 |
| Mg | 0-0.8 |
| Cu | 0.1-1.0 |
| V and/or Cr | <0.3 |
| Zn | <0.2 |
| Ti | <0.1 |
| Others | <0.05 each, <0.15 total |
| Al | Balance. |

26. Brazing sheet according to any one of claims 20 to 25, wherein the composition of the first Al alloy is in wt %:

| | First Alloy |
|---|---|
| Fe | <0.4 |
| Si | <0.2 |
| Mn | 0.7-1.7 |
| Mg | 0.1-0.8 |
| Cu | 0.1-1.0 |
| V and/or Cr | <0.3 |
| Zn | <0.2 |
| Ti | <0.1 |
| Others | <0.05 each, <0.15 total |
| Al | Balance. |

27. The brazing sheet of any one of claims 20 to 26, wherein the Mg from the core layer does not migrate beyond an interface between the core layer and the cladding layer and the Mg at the outer surface of the cladding layer is not increased.

28. The brazing sheet of any one of claims 20 to 27, further comprising a different Al alloy layer.

29. The brazing sheet of claim 28, wherein the different Al alloy layer is on the face of the core layer remote from the cladding layer.

30. The brazing sheet of claim 28, wherein the different Al alloy layer is on the cladding layer.

31. The brazing sheet of any one of claims 28 to 30, wherein the core layer comprises layers of two separated Al alloys which are both different from the cladding alloy.
